(19) United States
(12) Patent Application Publication
(10) Pub. No.: US 2024/0382950 A1
(43) Pub. Date: Nov. 21, 2024

(54) DECK ASSEMBLY FOR A DIAGNOSTIC SYSTEM

(71) Applicant: MYLAB DISCOVERY SOLUTIONS PRIVATE LIMITED, PUNE (IN)

(72) Inventors: Hasmukh Sohanraj Rawal, Pune (IN); Debarshi Bimal Dey, Mumbai (IN); Ketan Kamlesh Gajjar, Rajkot (IN)

(21) Appl. No.: 18/785,013

(22) Filed: Jul. 26, 2024

Related U.S. Application Data
(63) Continuation of application No. PCT/IB2023/050569, filed on Jan. 24, 2023.

(30) Foreign Application Priority Data
Jan. 28, 2022 (IN) 202221004919

(51) Int. Cl. B01L 3/00; B01L 7/00; G01N 35/10

(52) U.S. Cl. CPC B01L 3/5025; B01L 7/52; G01N 35/109; B01L 2200/04; B01L 2200/16; B01L 2300/18; G01N 2035/103

(57) ABSTRACT

Disclosed is a deck assembly for a diagnostic system, the deck assembly comprises a deck plate, a heating means, a cooling means and at least one insulation partition. Further, the deck plate, has a defined number of a set of place holders. Further, the heating means is mounted on the deck plate. Further, the cooling means is mounted on the deck plate. Further, the at least one insulation partition is mounted on the deck plate. Further, the at least one insulation is configured to provide insulation by restricting transfer of heat or cold from the at least one place holder from the set of place holders. Further, at least one place holder from the set of the place holder is enabled to discard piercing tips.

### CROSS REFERENCE TO RELATED APPLICATIONS

The present application is a Continuation application of PCT Application No. PCT/IB2023/050569 filed on Jan. 24, 2023, which claims the benefit of Indian Patent Application No. 202221004919 filed on Jan. 28, 2022. All the above are hereby incorporated by reference in their entirety.

### TECHNICAL FIELD

The present subject matter described herein, in general, relates to a field of a diagnostic system. More particularly, the present subject matter relates to a deck assembly for a diagnostic system and a method thereof.

### BACKGROUND

Nucleic acids (NA) are the main information-carrying molecules of the cell. Further, the nucleic acids (NA) are configured to determine the inherited characteristics of every living thing by directing the process of protein synthesis. Nucleic acids (NA) comprise a deoxyribonucleic acid (DNA) and a ribonucleic acid (RNA). Further, the deoxyribonucleic acid (DNA) is the master blueprint for life and constitutes a genetic material in all free-living organisms and most viruses. Further, the ribonucleic acid (RNA) is the genetic material of certain viruses, but it is also found in all living cells, where it plays an important role in certain processes such as the making of proteins. Further, the reasons stated above the nucleic acids (NA) is the basic object of molecular biology research. Further, the extraction of the nucleic acid (NA) is the most important criteria for the detection of disease and research. A method of extracting NA, DNA or RNA from biological sample comprises a traditional organic solvent extraction method, a column adsorption method and a magnetic bead partition method and the charge method. Further, the methods of extracting NA, DNA or RNA from biological sample are very laborious and time-consuming. The relatively large number of steps required to purify NA from such starting materials increase the risk of contamination of NA from sample to sample in the simultaneous processing of several clinical samples. When the NA is isolated for the subsequent detection of the presence of NA of, e.g., a pathogen (e.g., a virus or a bacterium) by means of a nucleic acid amplification method using the utmost sensitive Real Time polymerase-chain-reaction (RTPCR), the increased risk of such a contamination of NA between different samples which causes false positive results is a serious drawback. To overcome the above stated problems an automated diagnostic system is used for extracting NA, DNA or RNA from biological sample. Further, the automated diagnostic system comprises a set of tips to carry a biological reagent and a set place to perform different operations. Further, the challenge for an automated diagnostic system is in an automatic discarding of used set of tips and maintaining a defined temperature between a set of places or zones.

Thus, there is a long-standing need of a deck assembly for a diagnostic system which solves above mentioned problems.

### SUMMARY

This summary is provided to introduce the concepts related to a deck assembly for a diagnostic system and the concepts are further described in the detail description. This summary is not intended to identify essential features of the claimed subject matter, nor it is intended to use in determining or limiting the scope of claimed subject matter.

In one implementation, the deck assembly for a diagnostic system is disclosed. Further, the deck assembly comprises a deck plate, a heating means, a cooling means and at least one insulation partition. Further, the deck plate has a defined number of a set of place holders. Further, each place holder in the set of the place holder is distinct with respect to each other. Further, the heating means is mounted on the deck plate. Further, the heating means is integrated such that at least one place holder from the set of place holders is heated to a defined temperature. Further, the cooling means is mounted on the deck plate. Further, the cooling means is positioned such that at least one place holder from the set of place holders is cooled to a pre-defined temperature set by the diagnostic system. Further, the at least one insulation partition is mounted on the deck. Further, the at least one insulation is configured to provide insulation by restricting transfer of heat or cold from the at least one place holder from the set of place holders. Further, at least one place holder from the set of the place holder is enabled to discard and store, syringes, and piercing tips, wherein a storage module is mounted on the deck plate and is coupled to the at least one place holder from the set of place holders.

In another implementation, a method of a deck assembly for a diagnostic system for-automated nucleic acid extraction and Real Time PCR (RTPCR) reagent preparation is disclosed. The method comprises a step of transmitting a programmable command to a set of motors through drives and with a coupler by a control module, wherein the set of motors is configured to transmit motion to a ball screw mechanism assembly which in turn achieves motion for a deck plate of the deck assembly in a forward direction and a reverse direction. Further, picking a set of tips from a deck plate. Further, the deck plate comprises a set of place holders. Further, each place holder in the set of the place holder is distinct with respect to each other. Further, at least one insulation partition is mounted on the deck plate, wherein the at least one insulation partition is configured to provide insulation by restricting transfer of heat or cold from the at least one place holder from the set of place holders. Further the method comprises of entering a set of tips in a discarding zone of the set of place holders. Further, the discarding zone comprises a set of discard holes. Further, the set of discard holes comprises an enlarged section and a narrow section, wherein the set of tips is configured to enter at the centre of the enlarged section of the set of discard holes. Further, the method comprises moving the deck plate in a reverse direction. Further, the deck plate is configured to move in a reverse direction to align the set of tips with the narrow section of the set of discard holes. Furthermore, last step comprises of discarding, the set of tips. Further, the tips are separated in a discard box.

### BRIEF DESCRIPTION OF DRAWINGS

The detailed description is described with reference to the accompanying figures. In the Figures, the left-most digit(s) of a reference number identifies the Figure in which the reference number first appears. The same numbers are used throughout the drawings to refer like features and components.

FIG. 1 illustrates a deck assembly for a diagnostic system, in accordance with an embodiment of a present subject matter.

FIG. 2 illustrates a motion mechanism of the deck assembly for a diagnostic system, in accordance with an embodiment of a present subject matter.

FIG. 3 illustrates a heating and cooling assembly in the deck assembly for a diagnostic system, in accordance with an embodiment of a present subject matter.

FIG. 4 illustrates an insulation assembly for the deck assembly for a diagnostic system in accordance with an embodiment of a present subject matter.

FIG. 5a illustrates a set of places (500a) of the deck assembly (100) for a diagnostic system, in accordance with an embodiment of a present subject matter.

FIG. 5b illustrates a discarding zone (500b) of the deck assembly (100) for a diagnostic system, in accordance with an embodiment of a present subject matter.

FIG. 6 illustrates a deck plate (600) of the deck assembly (100) for a diagnostic system, in accordance with an embodiment of a present subject matter.

FIG. 7 illustrates a method (700) of a deck assembly (100) for a diagnostic system for automated nucleic acid extraction and Real Time PCR (RTPCR) reagent preparation, in accordance with an embodiment of a present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

The present disclosure illustrates a deck/table assembly for a diagnostic system. The deck assembly as disclosed may comprise a plurality of placeholder or receptables. The plurality of place holders may further be grouped into a plurality of sets based on functionality associated with each placeholder/receptable. The plurality of sets of the placeholder may be further arranged in a defined pattern based on the functionality of each set.

For e.g. a first set of placeholders or discard assembly may be configured to enable discarding of used pipettes or nozzles, cartridges of reagents, or specimen containers. Such first set of placeholders i.e. discard assembly may be positioned at a distal end of the deck assembly. Positioning the first set of placeholder/discard assembly at distal end ensures safety and reduced risk of contamination while testing multiple samples on the same deck assembly.

The discard assembly in accordance with another exemplary embodiment may comprise a plurality of cavities provided on a top surface of the deck assembly and a container positioned below the plurality of cavities. The cavities may have geometric shape resembling two circles with different diameter partially overlapping/intersecting with each other. At least one circle will have a smaller diameter in comparison to the other circle. Further consumables to be discarded like pipettes/nozzles, or cartridges are collected in the container once they are separated from a syringe assembly by the cavity.

In accordance with the exemplary disclosure each set with the plurality of placeholders enables the deck assembly to perform multiple diagnostic tests on multiple samples at same time. Further each placeholder may be in a form of cavity to accommodate specimen containers or cartridges with buffer and reaction solutions. The cavity may have pre-defined diameter or a geometric shape to accommodate the specimen containers or the cartridges.

Further the geometric shape may also vary and depend of the functionality of the particular/specific set of placeholders. In another exemplary embodiment one set of placeholders may have a shape looking similar to two circles intersecting with each other. Further one of the circles may have a smaller diameter and the other may have a larger diameter.

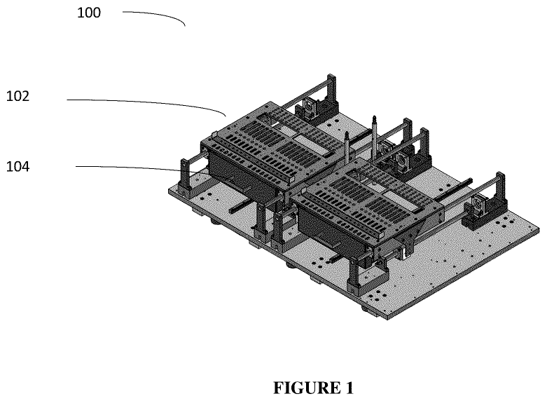

The present disclosure relates to a deck assembly (100) for a diagnostic system. In accordance with an exemplary embodiment, as illustrated in FIG. 1, a deck assembly (100) for a diagnostic system is disclosed. The deck assembly (100) may comprise a deck plate (102) with a plurality of place holders. The plurality of place holders may further be grouped into defined number of sets of place holders. Each set of the place holders may be distinct to each other with respect to functionality, action performed, and structurally. The plurality of place holders may be grouped as a first set for storing tips/piercing tips, a second set for storing processing sample tubes, a third set for storing extraction cartridges, a fourth set for storing elution tubes, a fifth set for storing RTPCR/extraction cartridges, a sixth set for storing RTPCR tubes, a seventh set for discarding the tubes, tips and pipettes, and an eighth set for holding specimen tube for shaking and heating.

In accordance with another exemplary embodiment of the deck assembly (100), the deck assembly may comprise two or more deck plates (102), with each deck plate (102) comprising plurality of place holders. The first set of place holders in accordance with either of the exemplary embodiments may further comprise a set of three rows of cavity/holders/receptacles on the deck plate (102) configured to store or hold the tips/piercing tips. Further, the first row from the set of three rows may comprise cavity/holders/receptacles having a diameter of 9.2 mm. Similarly, the second row from the set of three rows may have a diameter of 8.75 mm, and the third row may have a diameter of 9.1 mm.

Further, the second set for storing processing sample tubes, may be positioned adjacent to the first set. The second set may comprise one row of cavity or holders or receptacles having a diameter of 11.1 mm. The cavity or holders or receptacles may be configured or adapted to store or hold the processing sample tubes. Further the tubes may contain specific reagents and solution for performing plurality of diagnoses.

In accordance with the embodiment the eighth set may be positioned adjacent to and in close proximity to the second set. Further, the eighth set of place holder may have peripheral dimensions of 170×50 mm. The eight set of the place holder may be positioned between the second set on a first side and the third set of place holders on other side. Further, the third set of place holders may have a peripheral dimension of 170×80 mm. The third set of place holders may further be configured to store extraction cartridges and may comprise 8 slots.

Further, the fourth set of the place holder is positioned adjacent to the third set of place holder in the deck plate (102). The fourth set of the place holder may be configured to store an elution tube. The fifth set of the place holder is positioned on the deck plate, next to the fourth set, wherein the fifth set may comprise one row of 8 number of cavity or holders or receptacles with a diameter of 11.1 mm. The fifth set of place holders may hold RTPCR or extraction cartridges. Further the sixth set of place holder may be positioned next to the fifth set of place holder. Further, the sixth set of place holder may be configured to store RTPCR tubes.

In accordance with an embodiment, the deck plate having the sixth set of place holders further comprises the seventh set of place holders adjacent to the sixth set of place holders. The seventh set of place holders may be configured to enable discarding of tips, piercing tips, and pipettes. Further, the seventh set of place holders may comprise a set of discard places. Further, the set of discard places may comprise 8 places. Further, the set of discard places comprises an enlarged section and a narrow section. Further the enlarged section may comprise a hole having a diameter of 12.5 mm. Further, the narrow section may comprise a hole having a diameter of 8 mm. Further, the distance between centre of the enlarged section and the narrow section is 10 mm. Further, the deck plate (102) may be made of aluminium HE30 material. Further, deck plate (102) may be black and anodized. Further, the weight of the deck plate (102) is 1.95 kg. In another embodiment the deck assembly (100) may comprise a discard box (104). Further, the discard box may be positioned below the discarding zone of the deck plate (102). Further, the discard box may be configured to collect the discarded tips after use.

In accordance with the exemplary embodiment, the deck assembly (100) may comprise a heating means mounted on the deck plate (102), wherein the heating means is integrated such that at least one place holder from the set of place holders is heated to a defined temperature. Further, the deck assembly (100) may comprise a cooling means mounted on the deck plate (102). Further, the cooling means is positioned such that at least one place holder from the set of place holders is cooled to a pre-defined temperature set by the diagnostic system. Further, the deck assembly (100) may comprise at least one insulation partition mounted on the deck, wherein the at least one insulation partition is configured to provide insulation by restricting transfer of heat or cold from the at least one place holder from the set of place holders. Further, the deck assembly (100) may comprise a motion mechanism. Further, the motion mechanism comprises a threaded screw, a ball screw mechanism or assembly with tie rods and a set of motors.

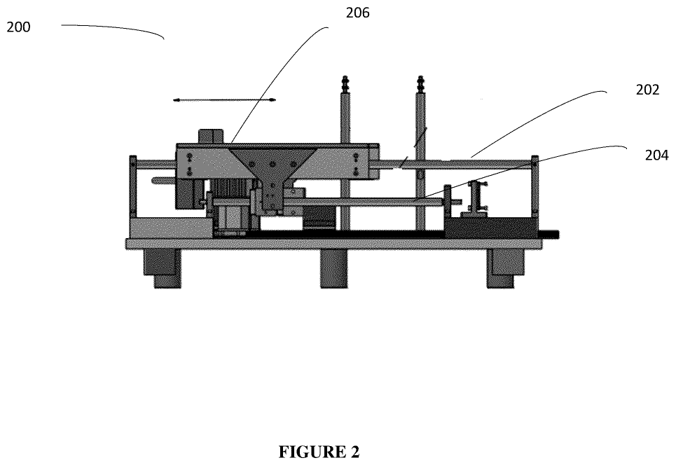

Now referring to FIG. 2, a motion mechanism (200) of the deck assembly (100) for a diagnostic system is illustrated, in accordance with an embodiment of the present subject matter. Further, the deck plate (206) may be configured to move in a forward and a reverse direction. Further, the motion mechanism (200) comprises a threaded screw (202), a ball screw mechanism or assembly (204) with tie rods and a set of motors. Further, the motion mechanism (200) may move the deck plate (206) in a forward and a reverse direction with high precision and accuracy. Further, the deck assembly (100) may comprise a control module. The control module may be configured to transmit a programmable command to the set of motors through drives and with a coupler, wherein the set of motors is configured to transmit motion to the ball screw mechanism or assembly (204) which in turn achieves motion for the deck plate in the forward and the reverse direction.

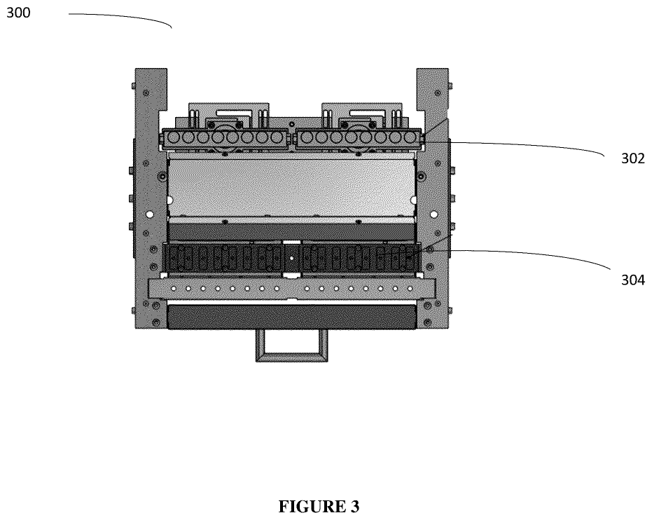

Now referring to FIG. 3, a heating and cooling assembly (300) of the deck assembly (100) for a diagnostic system is illustrated, in accordance with an embodiment of the present subject matter. Further, the heating and cooling assembly may comprise a heating means (302) mounted on the deck plate (102). Further, the heating means (302) may be integrated with the deck plate (102) such that at least one place holder from the set of place holders is heated to a defined temperature. Further, the heating means (302) is configured to heat the thermo-shaker assembly zone of the set of place holders. Further, the heating means (302) comprises an electric heater configured to heat the at least one place holder from the set of place holders in a range of 35° C. to 100° C. Further, the heating and cooling assembly may comprise a cooling means (304) mounted on the deck plate (102). Further, the cooling means (304) may integrate with the deck plate (102) such that at least one place holder from the set of place holders is cooled to a pre-defined temperature set by the diagnostic system. Further, the cooling means (304) is configured to cool the RTPCR or extraction cartridges storing zone of the set of place holders. Further, the cooling means (304) comprises a fluid jacket configured to cool the at least one place holder from the set of place holders in a range of 0° C. to 4° C.

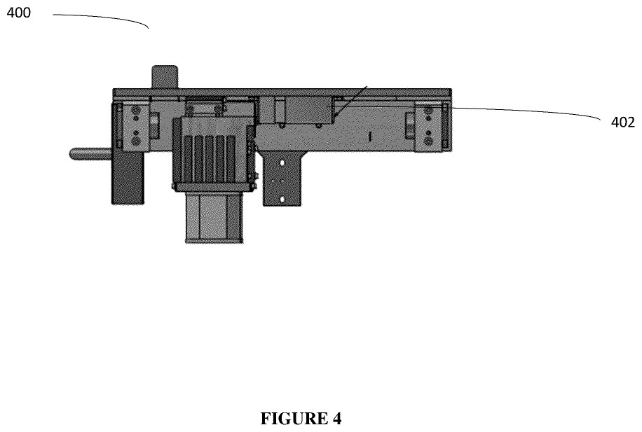

Now referring to FIG. 4, an insulation assembly (400), of the deck assembly (100) for a diagnostic system is illustrated, in accordance with an embodiment of the present subject matter. Further, the insulation assembly may comprise at least one insulation partition (402) mounted on the deck assembly (100). Further, the at least one insulation partition (402) is configured to provide insulation by restricting transfer of heat or cold from the at least one place holder from the set of place holders. In one embodiment the insulation partition (402) may comprise highly heat resistive material which may restrict transfer of heat. In another embodiment, the insulation partition (402) may be two insulating plates integrated such that an air gap may be produced between them to restrict the heat transfer. Further, at least one place holder from the set of place holders of the deck plate (102) may have temperature in a range of 35° C. to 100° C. Further, at least one place holder is in the thermo-shaker assembly zone. Further, the at least one place holder from the set of place holders of the deck plate (102) may have temperature in a range of 0° C. to 4° C. Further, the at least one place holder is the RTPCR or extraction cartridges storing zone. Further, the insulation partition (402) may be configured to restrict the heat transfer between the RTPCR or extraction cartridges storing zone and the thermo-shaker assembly zone.

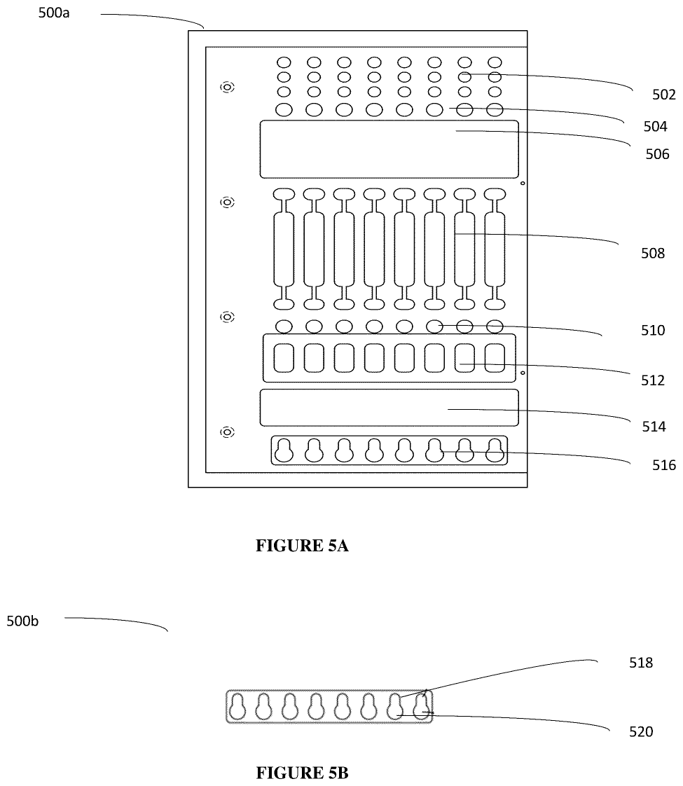

Now referring to FIG. 5a, a deck plate (500a) of the deck assembly (100) for a diagnostic system is illustrated, in accordance with an embodiment of the present subject matter. The deck plate (500a) may comprise tips or piercing tips storing zone or a first set of place holders (502) wherein the first set of place holders (502) may comprise a set of three rows of holes drilled on the deck plate. The holes may be configured to store the tips or piercing tips. Further, the first row of the set of three rows may comprise a hole 8 number of through holes of 9.2 mm diameter on the deck plate (102). Further, the second row of the set of three rows may comprise a hole 8 number of through holes of 8.75 mm diameter on the deck plate (102). Further, the third row of the set of three rows may comprise a hole 8 number of through holes of 9.1 mm diameter on the deck plate (102). Further, the sample processing tubes storing zone or a second set of place holder (504) may be positioned next to the tips or piercing tips storing zone (502). Further, the sample processing tubes (504) storing zone may comprise one row of 8 number of through holes of 11.1 mm diameter on the deck plate (102). Further, the sample processing storing zone (504) may be configured to store a tube. Further the tubes may contain a chemical solution for diagnosis. Further, the thermo-shaker assembly zone or eighth set of place holder (506) may be positioned next to the sample processing or tubes storing zone (504). Further, the thermo-shaker assembly zone (506) may have dimensions of 170×50 mm. Further, the heating means (302) may be configured to heat the thermo-shaker assembly zone (506). Further, the extraction cartridge storing zone or third set of place holders (508) may be positioned next to the thermo-shaker assembly zone (506). Further, the extraction cartridge storing zone or fourth set of place holders (508) may have dimensions of 170×80 mm. Further, the extraction cartridge storing zone (508) may be configured to store an extraction cartridge. Further, the extraction cartridge storing zone (508) may comprise 8 slots to hold 8 extraction cartridges. Further, the elution tube storing zone or a fifth set of holders (510) may be positioned next to the extraction cartridge storing zone (508). Further, the elution tube storing zone (510) may be configured to store an elution tube. Further, RTPCR or extraction cartridge storing zone or fifth set of place holder (512) may be positioned next to the elution tube storing zone (510). Further, the RTPCR or extraction cartridge storing zone (512) may be configured to hold RTPCR or extraction cartridges. Further, the cooling means (304) is configured to cool the RTPCR or extraction cartridges storing zone (512). Further the RTPCR tubes storing zone or sixth set of place holder (514) may be positioned next to the RTPCR or extraction cartridge storing zone (512). Further, the RTPCR tubes storing zone (514) may be configured to store RTPCR tubes. Further, the discarding zone or seventh set of place holders (516) may be positioned next to the RTPCR tubes storing zone (512). Further, the discarding zone (516) may comprise a set of discard places. Further, the set of discard places may comprise 8 places.

Now referring to FIG. 5b, a discarding zone (500b) of the deck assembly (100) for a diagnostic system is illustrated, in accordance with an embodiment of the present subject matter. Further, a set of discard places comprises an enlarged section (520) and a narrow section (518). Further the enlarged section (520) may comprise a hole of diameter 12.5 mm. Further, the narrow section (518) may comprise a hole of diameter 8 mm. Further, the distance between the centre of the enlarged section (520) and the narrow section (518) is 10 mm.

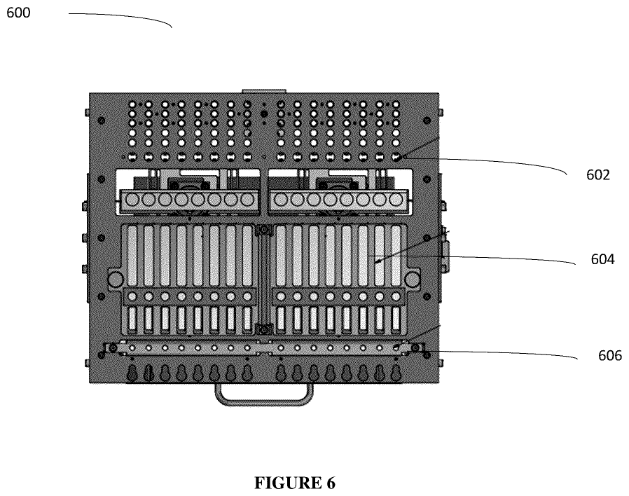

Now referring to FIG. 6, a deck plate (600) of the deck assembly (100) for a diagnostic system is illustrated, in accordance with an embodiment of the present subject matter. The deck plate (600) may comprise flaps (604), plunger (602) and a PCR tray (606). Further, the flaps (604) may be used to hold the cartridges within the deck plate (102). Further the plunger (602) may be configured to hold the sample tube within the deck. Further, the PCR tray (606) may be configured to hold the PCR tubes.

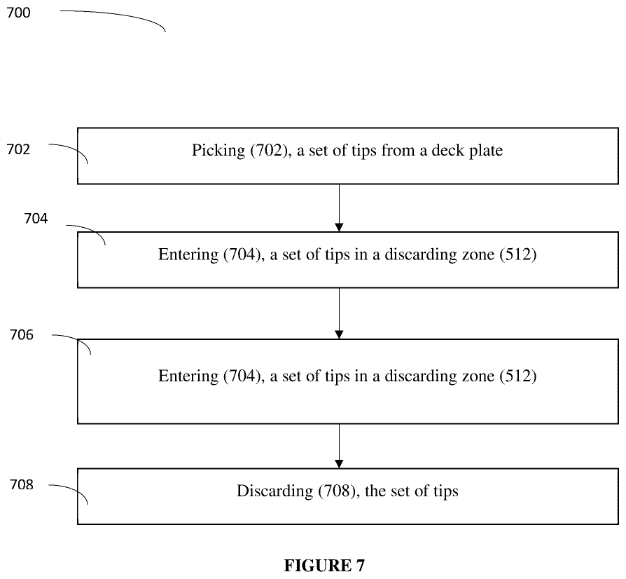

Now referring to FIG. 7, a method (700) of a deck assembly (100) for a diagnostic system for automated nucleic acid extraction and Real Time PCR (RTPCR) reagent preparation, the method is illustrated, in accordance with an embodiment of the present subject matter.

In an embodiment, the method comprises transmitting a programmable command to a set of motors through drives and with a coupler by a control module, wherein the set of motors is configured to transmit motion to a ball screw mechanism (204) which in turn achieves motion for a deck plate of the deck assembly in a forward direction and a reverse direction.

At step (702), the system may be configured for picking a set of tips from a deck plate. Further, the deck plate (102) comprises a set of place holders (502, 504, 506, 508, 510, 512). Further, each place holder in the set of the place holders (502, 504, 506, 508, 510, 512) is distinct with respect to each other. Further, at least one insulation partition (402) is mounted on the deck plate, wherein the at least one insulation partition (402) is configured to provide insulation by restricting transfer of heat or cold from the at least one place holder from the set of place holders (502, 504, 506, 508, 510, 512).

At step (704), the system may be configured for entering a set of tips in a discarding zone (512) of the set of place holders (502, 504, 506, 508, 510, 512). Further, the discarding zone (512) comprises a set of discard holes. Further, the set of discard holes comprises an enlarged section (516) and a narrow section (514), wherein the set of tips is configured to enter at the centre of the enlarged section (516) of the set of discard holes.

At step (706), the system may be configured for moving (706) the deck plate (102) in the reverse direction. Further, the deck plate (102) is configured to move in the reverse direction to align the set of tips with the narrow section (514) of the set of discard holes.

At step (708), the system is configured for discarding (708) the set of tips. Further, the tips are separated in a discard box (104).

The embodiments illustrated above, especially related to the deck assembly for a diagnostic system provide following advantages:
The system for deck assembly for a diagnostic system requires less time for automated nucleic acid extraction and Real Time PCR (RTPCR) reagent preparation.
The system for deck assembly for a diagnostic system decreases the risk of false positive results.
The system for deck assembly for a diagnostic system maintains accurately defined temperature ranges between the set of place holders of deck plate that increases the accuracy of process.
Further, the system for deck assembly for a diagnostic system is capable of discarding used tips after use that reduces the risk of contamination.

Various modifications to the embodiments will be readily apparent to those skilled in the art and the generic principles herein may be applied to other embodiments. However, one of ordinary skill in the art will readily recognize that the present disclosure is not intended to be limited to the embodiments illustrated but is to be accorded the widest scope consistent with the principles and features described herein.

The foregoing description shall be interpreted as illustrative and not in any limiting sense. A person of ordinary skill in the art would understand that certain modifications could come within the scope of this disclosure.

The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

1. A deck assembly (100) for a diagnostic system, the deck assembly comprising:
a deck plate (102), having at least two place holders selected from a set of place holders (502, 504, 506, 508, 510, 512), wherein each place holder in the set of the place holders (502, 504, 506, 508, 510, 512) is distinct with respect to each other, wherein the deck plate (102) is configured to move in a forward direction and a reverse direction;
a heating means (302) mounted on the deck plate (102), wherein the heating means (302) is integrated such that at least one place holder from the set of place holders (502, 504, 506, 508, 510, 512) is heated to a defined temperature;
a cooling means (304) mounted on the deck plate (102), wherein the cooling means (304) is positioned such that at least one place holder from the set of place holders (502, 504, 506, 508, 510, 512) is cooled to a pre-defined temperature set by the diagnostic system;
at least one insulation partition (402) mounted on the deck plate (102), wherein the at least one insulation partition (402) is configured to provide insulation by restricting transfer of heat or cold from the at least one place holder from the set of place holders (502, 504, 506, 508, 510, 512); and
wherein, the at least one place holder from the set of the place holders (502, 504, 506, 508, 510, 512) is enabled to discard and store, syringes and piercing tips, wherein a storage module is mounted on the deck plate (102) and coupled to the at least one place holder from the set of place holders (502, 504, 506, 508, 510, 512).

2. The deck assembly (100) for the diagnostic system as claimed in claim 1, wherein the set of the place holders (502, 504, 506, 508, 510, 512) further comprises a tips/piercing tips storing zone, a sample processing tubes storing zone, an extraction cartridge storing zone, an elution tube storing zone, a RTPCR/extraction cartridge storing zone, a RTPCR tubes storing zone, a discarding zone and a thermo-shaker assembly zone.

3. The deck assembly (100) for the diagnostic system as claimed in claim 1, wherein the heating means (302) comprises an electric heater configured to heat the at least one place holder from the set of place holders (502, 504, 506, 508, 510, 512) in a range of 35 Celsius to 100 Celsius.

4. The deck assembly (100) for the diagnostic system as claimed in claim 1, wherein the heating means (302) is configured to heat the thermo-shaker assembly zone of the set of place holders (502, 504, 506, 508, 510, 512).

5. The deck assembly (100) for the diagnostic system as claimed in claim 1, wherein the cooling means (304) comprises a fluid jacket configured to cool the at least one place holder from the set of place holders (502, 504, 506, 508, 510, 512) in a range of 0 Celsius to 4 Celsius.

6. The deck assembly (100) for the diagnostic system as claimed in claim 1, wherein the cooling means (304) is configured to cool the RTPCR/extraction cartridges storing zone of the set of place holders (502, 504, 506, 508, 510, 512).

7. The deck assembly (100) for the diagnostic system as claimed in claim 1, wherein the insulation cover (402) comprises two insulating plates of high heat resistant material.

8. The deck assembly (100) for the diagnostic system as claimed in claim 1, wherein the deck plate (102) is configured to move in forward and reverse direction using a motion mechanism (200), wherein the motion mechanism (200) comprises a threaded screw (202), a ball screw mechanism (204) with tie rods and a set of motors.

9. The deck assembly (100) for the diagnostic system as claimed in claim 1, wherein the deck assembly (100) comprises a control module.

10. The deck assembly for the diagnostic system as claimed in claim 9, wherein the control module is configured to transmit a programmable command to a set of motors through drives and with a coupler, wherein the set of motors is configured to transmit motion to the ball screw mechanism (204) which in turn achieves motion for the deck plate in the forward direction and the reverse direction.

11. The deck assembly for the diagnostic system as claimed in claim 1, wherein the discarding zone of the set of place holders (502, 504, 506, 508, 510, 512) comprises a set of discard places (512), wherein the set of discard places comprises an enlarged section (516) and a narrow section (514).

12. A method of a deck assembly for a diagnostic system for automated nucleic acid extraction and Real Time PCR (RTPCR) reagent preparation, the method comprising:
transmitting a programmable command to a set of motors through drives and with a coupler by a control module, wherein the set of motors is configured to transmit motion to a ball screw mechanism (204) which in turn achieves motion for a deck plate of the deck assembly in a forward direction and a reverse direction;
picking (702), a set of tips from the deck plate, wherein the deck plate (102) comprises a set of place holders (502, 504, 506, 508, 510, 512), wherein each place holder in the set of the place holder (502, 504, 506, 508, 510, 512) is distinct with respect to each other, wherein at least one insulation partition (402) is mounted on the deck plate, wherein the at least one insulation partition (402) is configured to provide insulation by restricting transfer of heat or cold from the at least one place holder from the set of place holders (502, 504, 506, 508, 510, 512);
entering (704), the set of tips in a discarding zone (512) of the set of place holders (502, 504, 506, 508, 510, 512), wherein the discarding zone (512) comprises a set of discard holes, wherein the set of discard holes comprises an enlarge section (516) and a narrow section (514), wherein the set of tips is configured to enter at the centre of the enlarged section (516) of the set of discard holes;
moving (706), the deck plate (102) in the reverse direction, wherein the deck plate (102) is configured to move in the reverse direction to align the set of tips with the narrow section (514) of the set of discard holes, and;
discarding (708), the set of tips, wherein the tips are separated in a discard box (104).
